(19) United States
(12) Patent Application Publication
(10) Pub. No.: US 2023/0223217 A1
(43) Pub. Date: Jul. 13, 2023

(54) SMALL KEYBOARD WITH ALTERNATIVE LAYOUTS FOR NUMBERS, EDITING, AND FUNCTION KEYS

(71) Applicant: Xincheng Wei, Dongguan City (CN)

(72) Inventors: Xincheng Wei, Dongguan City (CN); Hang Lu, Dongguan City (CN)

(21) Appl. No.: 17/621,661

(22) PCT Filed: Sep. 13, 2021
(86) PCT No.: PCT/CN2021/117949

§ 371 Date: Mar. 17, 2023

(30) Foreign Application Priority Data
Sep. 17, 2020 (CN) 202011006496.5

(51) Int. Cl. H01H 13/83; F21V 8/00

(52) U.S. Cl. CPC H01H 13/83; G02B 6/0008; G02B 6/005; H01H 2219/0621

(57) ABSTRACT

A small keyboard with alternative layouts for numbers, editing, and function keys, a main key zone of the keyboard comprising an editing alternative key zone, a numeric alternative key zone and an function alternative key zone; the editing alternative key zone corresponds to 15 keys in 3 rows and 5 columns on a left side of the main key zone; the numeric alternative key zone corresponds to 15 keys in 3 rows and 5 columns on a right side of the main key zone right; the function alternative key zone corresponds to 13 keys on a left side of a first row and 3 keys on a right side of a second row of the main key zone; when the Fn key function is activated, the second functions of all keys in the main key zone are activated.

### BACKGROUND OF INVENTION

### 1. Field of the Invention

The present invention relates generally to computer keyboard input, and more particularly to a small-size keyboard featuring an alternative layout of the numeric, editing and function key zones.

### 2. Description of Related Art

A full-size computer keyboard is mainly made up of 4 key zones, such as main key zone, editing key zone, numeric key zone and function key zone. Comparing to the full-size computer keyboard, in a small-size computer keyboard, only the main key zone is maintained, and the three other key zones of the editing key zone, the numeric key zone and the function key zone are canceled. The small-size keyboard offers many advantages, including less space occupation, portability, wireless Bluetooth connection, multiple device input, etc. However, as most users are accustomed to using full-size computer keyboards, when using a small-size computer keyboard, they may also need to use the keys in the editing key zone, numeric key zone, and function key zone of a full-size keyboard. Therefore, it is necessary that the small-size keyboard provides an alternative key layout to substitute for the numeric key zone, editing key zone, and function key zone of a full-size keyboard and offers an alternative input method.

At present, because of improper or faulty designs, the small-size computer keyboards of various kinds available on the market all have obvious shortcomings in different aspects. Example 1: All of them only provide an alternative key layout for the editing key zone and function key zone, and do not provide an alternative layout for the numeric key zone. Example 2: The keys in the editing alternative key zone are scattered. The keys are not positioned together and in an order similar to that of the editing key zone. There is no extension or optimization to the editing alternative key zone. Example 3: They only provide an alternative key entry mode based on combination keys, and do not provide an alternative key entry mode based on key locking. Example 4: The Fn combination function key is configured as a special function key, not a basic key, and can only be pressed by one hand, not by either hand. Example 5: The Fn combination key and Pn combination key are mixed together, not separated and optimized.

At present, the small-size computer keyboards available on the market provide neither alternative key layouts for all three key zones, i.e., the numeric key zone, the editing key zone, and the function key zone, nor alternative key entry modes for combination keys or key locking in an optimized form. Small-size keyboards of different brands are more or less different, not standardized in a uniform layout. This is because there is no common industrial standard to follow. As a result, the small-size keyboards cannot meet the requirement for functions that are equal to the full-size keyboard, not to say having a design better than the full-size keyboard. Therefore, it is necessary to provide an appropriate and optimized technical solution, and to establish an industrial technical standard as well as a global technical standard for small-size computer keyboards, so as to provide better keyboarding experience for small-size computer keyboard users. If the small-size computer keyboard products are optimized and standardized with full functions and better designs, they can improve input efficiency and be used more widely.

### SUMMARY OF THE INVENTION

The object of the present invention is to improve the above shortcomings, and to provide a small-size keyboard that offers an alternative key layout to substitute for the numeric, editing, and function key zones of the standard big-size keyboard. The keys in the numeric key zone, editing key zone, and function key zone of a big-size keyboard are alternatively configured in the main key zone through an alternative key entry mode. The layout is optimized and standardized to improve accuracy and efficiency, so that users can have better keyboarding experience.

To realize the above object, the main key zone of the keyboard disclosed in the present invention comprises an editing alternative key zone, an numeric alternative key zone and an function alternative key zone; the editing alternative key zone corresponds to 15 keys in 3 rows and 5 columns on the left side of the main key zone; the numeric alternative key zone corresponds to 15 keys in 3 rows and 5 columns on the right side of the main key zone, and the function alternative key zone corresponds to 13 keys on the left side of the first row and 3 keys on the right side of the second row of the main key zone;

In the main key zone of a QWERTY small-size keyboard, each key can correspondingly have a second key function, for example, the space bar key can function as an Fn key, the right Shift key can function as an FnLock key;

The QWERTY small-size keyboard comprises an editing alternative key zone. The editing alternative key zone includes 15 keys in 3 rows and 5 columns, i.e., Q key, W key, E key, R key, T key, A key, S key, D key, F key, G key, Z key, X key, C key, V key, and B key;

Each key in the editing alternative key zone corresponds to a second key function, i.e., Q key corresponds to Home function, W key corresponds to ↑ function, E key corresponds to End function, R key corresponds to PageUp function, T key corresponds to Insert function, A key corresponds to ← function, S key corresponds to ↓ function, D key corresponds to → function, F key corresponds to PageDown function, G key corresponds to Delete function, Z key corresponds to Undo function, X key corresponds to Cut function, C key corresponds to Copy function, V key corresponds to Paste function, and B key corresponds to Redo function.

The QWERTY small-size keyboard comprises an alternative layout for the numeric key zone. The numeric alternative key zone includes 15 keys in 3 rows and 5 columns, i.e., Y key, U key, I key, O key, P key, H key, J key, K key, L key, ; key, N key, M key, key, . key, and / key.

Each key in the numeric alternative key zone corresponds to a second key function, i.e., Y key corresponds to − function, U key corresponds to 7 function, I key corresponds to 8 function, O key corresponds to 9 function, P key corresponds to + function, H key corresponds to * function, J key corresponds to 4 function, K key corresponds to 5 function, L key corresponds to 6 function, ; key corresponds to 0 function, N key corresponds to / function, M key corresponds to 1 function, key corresponds to 2 function, . key corresponds to 3 function, and / key corresponds to . function.

The QWERTY small-size keyboard comprises an function alternative key zone. The function alternative key zone includes 16 keys, i.e., Esc key, 1 key, 2 key, 3 key, 4 key, 5 key, 6 key, 7 key, 8 key, 9 key, 0 key, − key, = key, [ key, ] key, and \ key.

Each key in the function alternative key zone corresponds to a second key function, i.e., Esc key corresponds to ′ function, 1 key incorporates F1 function, 2 key incorporates F2 function, 3 key incorporates F3 function, 4 key incorporates F4 function, 5 key incorporates F5 function, 6 key incorporates F6 function, 7 key incorporates F7 function, 8 key incorporates F8 function, 9 key incorporates F9 function, 0 key incorporates F10 function, − key incorporates F 11 function, = key incorporates F12 function, [ key incorporates Pause function, ] key incorporates ScrLK function, \ key incorporates PrtSc function.

In the main key zone of a QWERTY small-size keyboard, the corresponding second key function of each key is marked on the key cap of each key in the main key zone, Fn is marked on the key cap of the space bar key, and FnLock is marked on the key cap of the right Shift key.

In the main key zone of a QWERTY small-size keyboard, the corresponding second key function of each key is marked on the key cap of each key in the main key zone, Fn is marked on the key cap of the space bar key, and FnLock is marked on the key cap of the right Shift key.

When the space bar is pressed, the Fn key function is activated. When the space bar is released, the Fn key function is deactivated.

The user can press the right Shift key once to activate the Fn key function, and press the right Shift key once again to deactivate the Fn key function. If the right Shift key is pressed continuously for several times, the Fn key function will cycle between the activated mode and deactivated mode.

The user can hold down the Fn key or press the FnLock key once to activate the Fn key function, and the second key functions of all keys in the main key zone will be activated;

The user can release the Fn key or press the FnLock key once again to deactivate the Fn key function, and the second key functions of all keys in the main key zone will be deactivated.

Comparing to the full-size keyboard with 4 key zones and 104 keys used by most computer users, although the small-size keyboard disclosed in the present invention has canceled the editing key zone, numeric key zone, and function key zone, and only keeps the main key zone, it provides an editing alternative key zone, an numeric alternative key zone and an function alternative key zone in the main key zone of the small-size keyboard. The key entry of the editing key zone, numeric key zone, and function key zone can be realized alternatively by holding down the Fn key or pressing the FnLock key once in the main key zone. Thus, a 61-key small-size keyboard can realize equal functions as the 104-key full-size keyboard. It may even provide better keyboarding experience than the 104-key full-size keyboard.

### BRIEF DESCRIPTION OF THE DRAWINGS

FIG. 1 is a perspective view of Embodiment 1 of the present invention;

FIG. 2 is a perspective view of Embodiment 2 of the present invention.

### DETAILED DESCRIPTION OF THE INVENTION

The present invention provides alternative layouts for the editing key zone, the numeric key zone, and the function key zone by corresponding the 46 keys in the main key zone of a QWERTY small-size keyboard one by one to 15 numbers and symbols, 15 editing key prompt strings or icons, 16 function key prompt strings.

### Embodiment 1

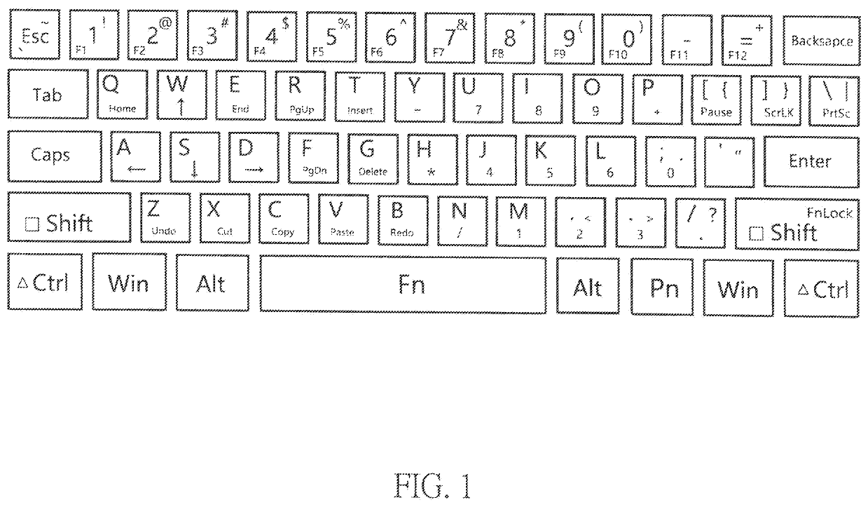

Referring to FIG. 1, on the 15 letter keys arranged in 3 rows and 5 columns in the main key zone for the left hand, i.e., Q key, W key, E key, R key, T key, A key, S key, D key, F key, G key, Z key, X key, C key, V key, B key, apart from showing the conventional letters, each of them correspondingly has an additional Home function sign, ↑ function sign, End function sign, PageUp function sign, Insert function sign, ← function sign, ↓ function sign, → function sign, PageDown function sign, Delete function sign, Undo function sign, Cut function sign, Copy function sign, Paste function sign, and Redo function sign. The 15 letter keys are additionally marked with 15 editing key prompt strings or icons. In this way, the keys in the editing key zone are arranged alternatively; on the 15 letter and symbol keys arranged in 3 rows and 5 columns in the main key zone for the right hand, i.e., U key, I key, 0 key, J key, K key, L key, ; key, M key, key, . key, P key, Y key, H key, N key, and / key, apart from showing the conventional letters or symbols, each of them correspondingly has an additional 7 function sign, 8 function sign, 9 function sign, 4 function sign, 5 function sign, 6 function sign, 0 function sign, 1 function sign, 2 function sign, 3 function sign, + function sign, − function sign, * function sign, / function sign, and . function sign. The 15 letter and symbol keys are additionally marked with 10 numbers and 5 symbols. In this way, the keys in the numeric key zone are arranged alternatively; on the 16 number and symbol keys arranged in the row of numeric keys in the main key zone, i.e., Esc key, 1 key, 2 key, 3 key, 4 key, 5 key, 6 key, 7 key, 8 key, 9 key, 0 key, − key, = key, and on the right most of the neighboring row, i.e., [ key, ] key, and \ key, apart from showing the conventional numbers or symbols, each of them correspondingly has an additional ′ function sign, F 1 function sign, F2 function sign, F3 function sign, F4 function sign, F5 function sign, F6 function sign, F7 function sign, F8 function sign, F9 function sign, F10 function sign, F11 function sign, F12 function sign, ScrLK function sign, Pause function sign, and PrtSc function sign. There are totally 16 function key prompt strings. In this way, the keys in the function key zone are arranged alternatively.

For example: as shown in FIG. 1, on the standard letter key U in the main key zone of the small-size keyboard, apart from showing the conventional letter U, there is an additional mark of number 7. In this way, the numeric key 7 in the numeric key zone is alternatively arranged in the main key zone; on the standard letter key Q in the main key zone of the small-size keyboard, apart from showing the conventional letter Q, there is an additional mark of editing key prompt string Home. In this way, the editing key Home in the editing key zone is alternatively arranged in the main key zone; on the numeric key 2 in the row of numeric keys in the main key zone of the small-size keyboard, apart from showing the conventional Number 2, there is an additional mark of function key prompt string F2. In this way, the function key F2 in the function key zone is arranged alternatively in the main key zone.

The layout of the keys will be determined by the default settings of the keyboard manufacturers or computer manufacturers and user-defined settings, for example, whether or not the 15 numbers or symbols, 15 editing key prompt strings or icons, 16 function key prompt strings are additionally and correspondingly shown on the 46 letter and symbol keys in the main key zone of the small-size keyboard; or which letter and symbol keys in the main key zone of the computer keyboard are additionally and correspondingly shown with the numbers or symbols, editing key prompt strings or icons, or function key prompt strings; or how the letter and symbol keys in the main key zone of the computer keyboard correspond to the numbers or symbols, editing key prompt strings or icons, or function key prompt strings one by one, respectively.

For example, based on the default settings of Cherry (a keyboard manufacturer), on the 46 letter and symbol keys in the main key zone of a standard Cherry small-size keyboard, there are additional marks of 15 numbers or symbols, 15 editing key prompt strings or icons, and 16 function key prompt strings, one by one corresponding to each other. In this way, the numeric key zone, editing key zone, and function key zone are provided alternatively in the main key zone. Based on the default settings of IKBC (a keyboard manufacturer), on the 41 letter and symbol keys in the main key zone of a standard IKBC small-size keyboard, there are additional marks of 10 numbers and 5 symbols, 10 editing key prompt strings or icons, and 16 function key prompt strings. In this case, the editing key zone is provided alternatively only basically, not optimally.

Another example is that based on the default settings of HHKB (a keyboard manufacturer, on the 30 letter and symbol keys arranged in 3 rows and 10 columns in the main key zone of a standard HHKB small-size keyboard key, there are no additional and corresponding marks of 15 numbers or symbols and 15 editing key prompt strings or icons. Only the editing key zone is provided in an alternatively layout; based on user-defined settings, by replacing the keyboard key caps, on the 30 letter and symbol keys arranged in 3 rows and 10 columns in the main key zone of the standard HHKB small-size keyboard key, there can be additional and corresponding marks of 15 numbers or symbols and 15 editing key prompt strings or icons. In this way, the editing key zone and numeric key zone are provided in an alternative layout. Plus the existing alternative layout of keys in the function key zone, the HHKB small-size keyboard will provide full functions and better keyboarding experience.

At present, in the main key zone of the computer keyboard, each letter key only shows one upper case letter or lowercase letter. Based on the present invention, each letter key will additionally show one number or symbol, editing key prompt string or icon. At present, in the main key zone of the computer keyboard, each of the 10 numeric keys in the row of numeric keys only shows one number and one symbol. Based on the present invention, each of the 10 letter and symbol keys will additionally show one function key prompt string. At present, in the main key zone of the computer keyboard, each of the 10 symbol keys only shows two symbols. Based on the present invention, each of the 10 symbol keys will additionally show one number or symbol, or one function key prompt string.

The letter and symbol keys in the main key zone disclosed in the present invention are marked in a style similar to the numeric keys in the numeric key zone. For example, on each of the 9 numeric keys in the numeric key zone of a full-size keyboard, apart from showing one number, there is an additional mark of an editing key prompt string or icon. Similarly, on each of the 26 letter keys in the main key zone of the small-size keyboard according to the present invention, apart from showing one letter, there is an additional mark of an editing key prompt string or icon, a number or a symbol. According to the present invention, the additional marks of the numbers or symbols, editing key prompt strings or icons, or function key prompt strings of each letter and symbol key in the main key zone are by default shown on top of each letter or symbol key. They can also be provided on the lateral side of each letter and symbol key, as needed, just like some kinds of laterally etched computer keyboards, where the additional marks of numbers or symbols, editing key prompt strings or icons, or function key prompt strings are shown on the lateral side of each letter or symbol key.

On the full-size keyboard, the function key zone, editing key zone, and numeric key zone are configured in separate spaces. Similarly, in the small-size keyboard disclosed in the present invention, the alternatively arranged function key zone, editing key zone, and numeric key zone are also configured in separate spaces. Because the numeric key zone is by default located on the topmost of the full-size keyboard, the keys in the alternative layout of the numeric key zone are mainly located on the topmost row of the main key zone and on the right most of the lower neighboring row. Because the editing key zone in the full-size keyboard is located relatively on the left side and the numeric key zone is located relatively on the right side, the standard keys in the main key zone are divided into two parts from the middle, the keys in the alternative layout of the editing key zone are by default located on the 15 left-hand key positions in the main key zone distributed in 3 rows and 5 columns, while the keys in the alternative layout of the numeric key zone are by default located on the 15 right-hand key positions in the main key zone distributed in 3 rows and 5 columns.

The technique to realize alternative layout of the keys in the numeric key zone, editing key zone, and function key zone through additional marks of the corresponding numbers or symbols, editing key prompt strings or icons, and function key prompt strings on the basis of the conventional marks of the letter, number, and symbol keys in the main key zone is commonly known to those skilled in the art. The present invention does not have any limitation to the technical means adopted to realize the additional marks of the numbers or symbols, editing key prompt strings or icons, or function key prompt strings on the multiple keys in the main key zone.

In the present invention, A key corresponds to ← function sign, D key corresponds to → function sign, W key corresponds to ↑ function sign, S key corresponds to ↓ function sign, Q key corresponds to Home function sign, E key corresponds to End function sign, R key corresponds to PageUp function sign, F key corresponds to PageDown function sign, T key corresponds to Insert function sign, G key corresponds to Delete function sign, Z key corresponds to Undo function sign, X key corresponds to Cut function sign, C key corresponds to Copy function sign, V key corresponds to Paste function sign, and B key corresponds to Redo function sign, so that an alternative layout of the keys in the editing key zone is realized in the main key zone, and the editing key zone is extended and optimized.

For example, by default, on the 4 letter keys set as Up, Down, Left, and Right editing keys, each correspondingly has an additional direction arrow mark of ↑ ↓ ← and →, instead of showing 4 editing key prompt strings of Left, Right, Up, and Down. On the 6 letter keys set as Home, End, PageUp, PageDown, Insert, and Delete editing keys, each can also have an additional and corresponding abbreviated string like home, end, pgup, pgdn, Ins, or Del, instead of corresponding complete string. On the 5 letter keys set as Undo, Cut, Copy, Paste, and Redo editing keys, each can be correspondingly marked with an additional Undo, Cut, Copy, Paste, or Redo editing key prompt string, or correspondingly marked with an additional editing key prompt icon. The editing key prompt strings or icons are by default shown on top of each letter key, just as in the numeric key zone, the editing key prompt strings or icons are by default shown on top of the numeric keys. The editing key prompt strings or icons are also be marked on the lateral side of each letter key, just as in some kinds of laterally etched computer keyboards, the editing key prompt strings or icons are shown on the lateral sides of the keys.

In a full-size keyboard, the editing key zone is provided on the neighboring right side of the main key zone, and generally includes 10 editing keys, i.e., Insert, Delete, Home, End, PageDown, PageUp, Left, Right, Down, and Up. Because the small-size keyboard has canceled the editing key zone, the main key zone must provide alternative keys for those keys in the editing key zone. Therefore, an alternative key layout is provided to adapt to the operation habit of full-size keyboards and to provide similar or better keyboarding experience. The present invention configures the 10 editing keys in the editing key zone in one-to-one correspondence on the 10 basic left-hand letter keys in 2 rows and 5 columns in the main key zone, i.e., Q key, W key, E key, R key, T key, A key, S key, D key, F key, and G key. Thus, the user does not need to move his/her hand away from the basic keys in the default main key zone to the editing key zone. The editing key operation can be directly realized according to the indications just by moving the finger slightly between the basic left-hand keys in the main key zone. The input experience in editing operation will be significantly enhanced.

As Shift+Delete=Cut, Ctrl+Insert=Copy, and Shift+Insert=Paste, the Cut, Copy, and Paste functions can be considered as extensions of the 10 editing keys. And Ctrl+Z=Undo, Ctrl+X=Cut, Ctrl+C=Copy, and Ctrl+V=Paste are the most commonly used Ctrl combination key operations. And they happen to be located on the standard left-hand letter keys on the downmost row of the main key zone. Therefore, the letter keys Z X C V B are additionally configured with the 5 editing key strings or icons of Undo, Cut, Copy, Paste, and Redo. Such an extension and optimization of the editing key is a very good design to greatly enhance the overall experience in editing operations.

It is dependent on the default settings of the keyboard manufacturers or computer manufacturers and user-defined settings whether or not to add 15 editing key prompt strings or icons in one-to-one correspondence on the 15 standard left-hand keys in 3 rows and 5 columns in the main key zone of the computer keyboard; or on which standard left-hand keys are the additional editing key prompt strings or icons are configured in one-to-one correspondence; or which editing key prompt strings or icons are additionally configured on a plurality of standard left-hand keys in one-to-one correspondence; or how does each of the standard left-hand keys correspond to each editing key prompt string or icon.

For example: Based on default settings of Logitech, in the main key zone of the Logitech external small-size keyboard, the 15 standard left-hand keys in 3 rows and 5 columns have 15 additional editing key prompt strings or icons, i.e., Q key, W key, E key, R key, T key, A key, S key, D key, F key, G key, Z key, X key, C key, V key, and B key respectively and correspondingly has an additional Home, Up, End, PageUp, Insert, Left, Down, Right, PageDown, Delete, Undo, Cut, Copy, Paste, and Redo editing key prompt string or icon; Based on the default settings of CHERRY, in the main key zone of the CHERRY external small-size keyboard, only 10 standard left-hand keys in 2 rows and 5 columns are added with 10 editing key prompt strings or icons, i.e., Q key, W key, E key, R key, T key, A key, S key, D key, F key, and G key respectively and correspondingly added with a Home, Up, End, PageUp, Insert, Left, Down, Right, PageDown, and Delete editing key prompt string or icon, instead of showing 15 editing key prompt strings or icons on all of the 15 letter keys in 3 rows and 5 columns, in one-to-one correspondence.

For example, based on the default settings of HHKB, the 2 keys T and G on the HHKB small-size keyboard have 2 corresponding additional editing key prompt strings or icons, i.e., Insert and Delete; Based on the default settings of RK, the 2 keys T and G on the RK small-size keyboard have 2 corresponding additional editing key prompt strings or icons, i.e., BackSpace and Delete, thus providing an overall optimized design for the delete operation; Based on user-defined settings, by replacing the key caps of the mechanical keyboard and modifying the driver setting, the 2 keys T and G on the RK small-size keyboard can have 2 corresponding additional editing key prompt strings or icons, i.e., Insert and Delete, thus providing a perfect substitution for the full-size keyboard editing key zone.

At present, by default, most computer games preset the 4 keys of A key, S key, D key, and W key on the computer keyboard as up, down, left and right direction keys. In the alternative key layout of the present invention, the editing alternative key zone with standard left-hand keys in the main key zone is preset to be compatible to the conventional A, S, D and W direction key layout. However, the 4 direction keys of A, S, D, and W in the present invention can be used not just in games. The user can operate up, down, left and right direction key operations through the 4 keys of A, S, D, and W.

At present, in most Windows computer application programs, the 4 letter keys of Z, X, C and V are by default used as Ctrl combination keys for 4 commonly used editing operations, i.e., Undo, Cut, Copy, and Paste. In the editing key zone of a full-size keyboard, there are 10 editing keys for 10 editing operations. Among these, Cut, Copy, Paste, Undo, and Redo are also the most frequently used editing operations. Based on the present invention, using the 5 keys of Z, X, C, V, and B for the 5 most frequently used Cut, Copy, Paste, Undo, and Redo editing operations is obviously a better choice than using the Ctrl combination keys for the common editing operations. The present invention provides users with a better choice while fully maintaining the compatibility to the conventional editing operation habit. The editing operations become more accurate, efficient, and standardized, offering users with better editing operation.

In the main key zone of the computer keyboard, the 15 letter and symbol keys in 3 rows and 5 columns as right-hand basic keys, i.e., U key, I key, O key, J key, K key, L key, ; key, M key, key, . key, P key, Y key, H key, N key, and / key are respectively and correspondingly added with 7 function sign, 8 function sign, 9 function sign, 4 function sign, 5 function sign, 6 function sign, 0 function sign, 1 function sign, 2 function sign, 3 function sign, + function sign, − function sign, * function sign, / function sign, and . function sign, in total 10 numbers and 5 symbols.

The preset numeric key zone of a full-size keyboard comprises 17 keys, including 10 numbers and 5 symbols. In the present invention, 10 numbers and 5 symbols in the numeric key zone are marked on the 15 right-hand basic keys in 3 rows and 5 columns in the main key zone of the small-size keyboard, so as to realize an alternative key layout for the numeric key zone; meanwhile, by default, a compatible numeric key layout with 9 numbers in 3 rows and 3 columns are adopted to be best compatible to the conventional layout of the numeric keys and symbol keys in the numeric key zone, thus offering a certain compatibility to the habit of entering numbers and symbols in the numeric key zone.

On the rightmost of the main key zone, an Enter function key is provided; and the RightShift is by default configured as the FnLock function key, a key similar to the NumLock key. Thus, the alternative layout of the numeric key zone with 15 right-hand basic keys in the main key zone, plus the two close function keys of Enter and Fnlock, virtually form an alternative layout of the entire 17 keys in the numeric key zone.

It is determined by the default settings of the keyboard manufacturers or computer manufacturers and user-defined settings whether or not to have additional marks of 10 numbers and 5 symbols on the 15 letter and symbol keys in 3 rows and 5 columns as right-hand basic keys in the main key zone of the computer keyboard, in one-to-one correspondence; or among the standard right-right keys, which letter and symbol keys are additionally marked with corresponding numbers or symbols one by one; or which numbers or symbols are additionally shown in one-to-one correspondence on a plurality of standard right-hand letter and symbol keys; or how each of the standard right-hand letter and symbol keys corresponds to the each of the number and symbol signs.

In the present invention, the layout of numeric keys in 3 rows and 4 columns on the right-hand basic keys in the main key zone of the computer keyboard has many advantages. For example: as the alternative layout of the numeric key zone is located in the main key zone, when using one hand for number entry operations, the user needs only to move his/her fingers instead of the arm; mistaken operations due to inaccurate key positioning is virtually impossible; instead of using two hand, the user just needs to use one hand to input all 10 numbers; in case of continuous entry of many numbers, the efficiency and accuracy will be considerably increased; all computer keyboards that provide a main key zone can provide an alternative layout of numeric keys based on the right-hand basic keys, thus realizing a standardized key layout for single hand entry of numbers.

At present, in a full-size keyboard, by default, two numeric key layouts are provided, i.e., one numeric key layout in 4 rows and 3 columns in the numeric key zone and one numeric key layout in 1 row and 10 columns in the main key zone. The present invention provides a third type of numeric key layout for computer keyboards, i.e., the numeric key layout formed by right-hand basic keys in 3 rows and 4 columns in the main key zone. Thus, the numeric key layout on a computer keyboard is increased from 2 types to 3 types. The completely new numeric key layout not only provides more options for users, but also makes single hand number input more efficient, accurate, and standardized.

At present, in most cases, numbers are input through the row of numeric keys in the main key zone of the computer keyboard. However, the numeric key layout in the row of numeric keys has many disadvantages. For example, the row of numeric keys is located above the neighboring basic keys, not among the basic keys. Therefore, to input numbers, the user not only needs to move his/her fingers, but also needs to move the arms. For example: as the row of numeric keys are not located among the basic keys, during keyboarding, the probability of faulty operation due to inaccurate key positioning is obviously higher, especially when entering numbers 5, 6 etc. For example: as the numeric keys are laid out in 1 row and 10 columns, the user has to use both hands for the input operation, not like the numeric key zone that enables single hand operation. For a further example, in cause of continuous entry of many numbers, single-hand operation through the numeric key zone is an obviously better choice than double-hand operation through the row of numeric keys. Therefore, it is necessary to provide an alternative single-hand input method through the main key zone to enhance accuracy and efficiency.

In the existing full-size keyboard, the numeric keys in 1 row and 10 columns in the main key zone are arranged in a double-hand numeric key layout, and the numeric keys in 4 rows and 3 columns in the numeric key zone are arranged in a single-hand numeric key layout, respectively used to meet the needs for double-hand number input and single-hand number input. However, the small-size keyboard has canceled the numeric key zone, only providing the double-hand numeric key layout in the main key zone, in 1 row and 10 columns, and can only meet the need for double-hand number input. Therefore, it is necessary to add a new numeric key layout in the main key zone. In this way, even without a numeric key zone, the small-size keyboard can meet both needs for double-hand input and single-hand input.

Apart from the 10 numeric keys, the numeric key zone of the existing full-size keyboards also comprises 7 other keys, including 5 symbol keys of +, *, /, and .. Because the right-hand basic keys on the computer keyboard include 15 letter and symbol keys, apart from showing 10 numbers, the right-hand basic keys can also show 5 symbols including +, *, / and .. Thus, the numeric key layout formed by the right-hand basic keys in the small-size keyboard is compatible to the key layout in the numeric key zone.

The numeric key layout through the right-hand basic keys on the computer keyboard is adopted to optimize the number entry operation, and also to resemble the numeric key zone for number entry and operation, so as to meet the industrial and professional need for a special accounting keyboard. Entering numbers through the 10 letter and symbol keys of U, I, O, J, K, L, ;, M, and . has many advantages. For example, location on the basic keys facilitates single-hand entry. It is particularly good for pure numeric entry. Because most numeric entry cases are pure number input, not professional accounting entry through the numeric key zone, the numeric key layout through the right-hand basic keys provided by the present invention will become a preferred numeric key layout, and numeric entry through the numeric key layout based on the right-hand basic keys will become a preferred single-hand number entry method for most users.

At present, in the main key zone of some notebook computer keyboards, a plurality of letter and symbol keys (7, 8, 9, U, I, O, J, K, L, M, etc.) are configured to show the numbers or symbols in one-to-one correspondence to resemble the numeric key zone, so as to facilitate single-hand number entry or accounting operations. However, due to many shortcomings, such a configuration is not appropriate and complete. For example, not all of them are located on the right-hand basic keys of computer keyboard; it only provides a key locking input mode, and does not provide a key combination input mode; there is no consideration of the overall key layout of the small-size keyboard; it is not compatible to the key layout of the numeric key zone to the highest degree. In the present invention, the right-hand basic keys in the main key zone are configured with a totally new alternative key layout of the numeric key zone, to obtain better single-hand number entry experience and accounting keyboard operation experience.

In the conventional computer keyboard, the 10 numeric keys in the row of numeric keys additionally show 10 function key prompt strings, in one-to-one correspondence; and the other 3 symbol keys in the row of numeric keys additionally show 3 function key prompt strings of Esc, F11, F12, in one-to-one correspondence; also, the 3 symbol keys on the rightmost side of the neighboring row below the row of numeric keys additionally show function prompt strings of the 3 function keys of ScrLK, Pause and PrtSc.

For example, referring to FIG. 1, the 10 numeric keys, i.e., 1, 2, 3, 4, 5, 6, 7, 8, 9 and 0, in the row of numeric keys on the small-size keyboard additionally show 10 function key prompt strings, i.e., F1, F2, F3, F4, F5, F6, F7, F8, F9, and F10; the two symbol keys − and =neighboring the numbers key 0 on the right side additionally show 2 function key prompt strings F11 and F12, in one-to-one correspondence; the symbol key ′ on the leftmost of the row of numeric keys additionally show an Esc function key prompt string; furthermore, the three symbol keys on the rightmost of the neighboring row below the row of numeric keys, i.e., the three symbol keys [, ], and \ neighboring the letter P on the right side additionally show prompt strings of the 3 function keys of ScrLK, Pause and PrtSc.

It is determined by the default settings of the keyboard manufacturers or computer manufacturers and user-defined settings whether or not to additionally show 13 function key prompt strings on the row of numeric keys on the computer keyboard in one-to-one correspondence, and to additionally show 3 function key prompt strings on the rightmost side of the neighboring row below the row of numeric keys in one-to-one correspondence; how the 13 function key prompt strings correspond to the 13 number key signs in the row of numeric keys, and how the 3 function key prompt strings correspond to the 3 symbol keys on the rightmost side of the neighboring row below the row of numeric keys.

For example, based on the default settings of IKBC, the 13 letter and symbol keys, i.e., ′, 1, 2, 3, 4, 5, 6, 7, 8, 9, 0, −, and =, in the row of numeric keys on the IKBC external small-size keyboard, additionally show 13 function key prompt strings, i.e., Esc and F1 to F12, in one-to-one correspondence, and the 3 symbol keys on the rightmost side of the neighboring row below the row of numeric keys, i.e., [, ] and \, additionally show the prompt strings of 3 function keys of ScrLK, Pause and PrtSc; Based on the default settings of RK, the 13 letter and symbol keys, i.e., ′, 1, 2, 3, 4, 5, 6, 7, 8, 9, 0, −, and =, in the row of numeric keys on the RK external small-size keyboard, additionally show 13 function key prompt strings, i.e., Esc and F1 to F12, in one-to-one correspondence, and the 3 symbol keys on the rightmost side of the neighboring row, i.e., [, ], and \, additionally show 3 function key prompt strings, i.e., PrtSc, ScrLK, and Pause, in one-to-one correspondence. For the 3 function keys of PrtSc, ScrLK, and Pause, the small-size keyboards of both companies have different orders.

On a standard full-size keyboard, the function key zone is located on the topmost, and normally comprises 16 function keys, mainly including 12 function keys of F1 to F12, the Esc function key on the neighboring left side, and the 3 function keys of PrtSc, ScrLK, and Pause on the neighboring right side. Because the small-size keyboard has canceled the function key zone, the main key zone must provide an alternative key layout for the function key zone, so as to be compatible to the operation habit and keyboarding experience of using a full-size keyboard.

At present, on most conventional small-size keyboards, an alternative key layout is provided on the row of numeric keys, including 13 function keys, i.e., in the order from left to right, Esc function key and F1 to F12 functions keys. This is the best and the only choice for an alternative key layout on the small-size keyboard for the function key zone, and has in fact become a technical standard. However, for the 3 function keys of PrtSc, ScrLK, and Pause, the alternative layouts are not standardized and optimized. The present invention configures them on the 3 symbol keys on the rightmost side of the neighboring row below the row of numeric keys, making a uniform and proper layout.

At present, most users seldom or never use the two functions keys of ScrLK and Pause, but frequently use the PrtSc function key to capture a screenshot. Therefore, the default order of the 3 function keys PrtSc, ScrLK, and Pause is changed, putting the PrtSc on the rightmost side. This is not only because the key \ has larger width, but also for easier operation. With such a configuration, faulty operations will seldom happen, and users will have better function key entry experience.

The space bar on the computer keyboard is configured as Fn function key, and the Fn function key is configured to show such corresponding function prompt strings or icons as Fn, FnSpace, SpaceFn, Fn+Space, Space+Fn, Edit+Num, Edit+Num+Space etc.

### Embodiment 2

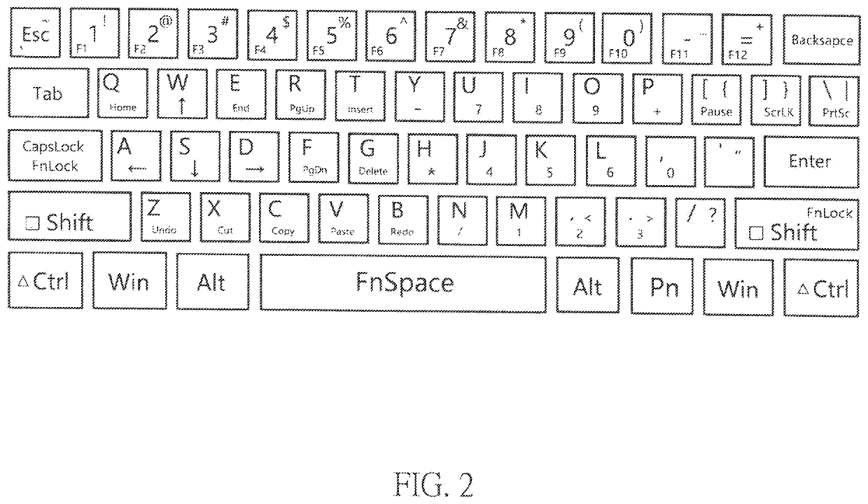

Referring to FIG. 2, according to the present invention, if the small-size keyboard only provides 1 physical space bar, the driver of the computer keyboard can only configure the only space bar as the Fn function key, and the Fn function key shows the function prompt string FnSpace, providing a simple and obvious indication that the space bar has two key functions of Fn and Space at the same time.

If the small-size keyboard provides 2 physical space bars, the keyboard function enhancement software installed in the computer can configure the left space bar as the Fn function key, and the Fn function key shows a function prompt string Fn+Space. The function prompt string Fn+Space shown in the space bar provides a simple and obvious indication that the space bar has two key functions of Fn and Space at the same time.

For example, if the small-size keyboard provides 3 physical space bar, the computer keyboard driver can preset the middle space bar as the Fn function key, and the Fn function key shows the function prompt string Edit+Num+Space, to indicate that this space bar can not only be used to input a space character, but also be used in the form of key combination for other functions like editing operation or number entry etc.

For example, on the small-size keyboard that provides 1 physical space bar, the only space bar will not by default be configured as the Fn function key, and the only space bar will not show the corresponding function prompt string Fn; by downloading and installing keyboard function extension software such as NeweasyKeyboard, the only space bar can be user-defined as the Fn function key; also, by changing the key caps of the mechanical keyboard, the only space bar can show the corresponding function prompt string FnSpace.

For example: Based on the default settings of computer keyboard manufacturer Logitech, on the Logitech small-size keyboard that provides 2 physical space bar, the left space bar is configured as the Fn function key, and the Fn function key shows the function prompt string Fn; Based on the default settings of the keyboard manufacturer CHERRY, on the Cherry small-size keyboard that provides 2 physical space bars, the right space bar is configured as the Fn function key, and the Fn function key shows the function prompt string FnSpace; Users can download, install and run keyboard function enhancement software to define the left space bar as the Fn function key, and change the key cap of the mechanical keyboard to show the function prompt string Fn+Space on the left Fn function key.

In the present invention, a space bar is configured as the preset Fn combination function key to be used to substitute the key entry of the editing key zone and function key zone. Therefore, the Fn function key only shows a Fn, making it better compatible to the conventional cognitive mode, visual experience and operation habit of users. And showing other function prompt strings like a FnSpace or Fn+Sapce on the Fn function key can provide a better indication that the space bar can have two key functions of Space and Fn at the same time.

After the Fn function key is by default configured to substitute the numeric key zone, editing key zone, and function key zone for key entry, it can also be used as a combination function key for Bluetooth connection, lighting effect configuration, multimedia operation, user-defined programming etc, and it will by default show Pn. This will also become an established technical standard for small-size keyboards. The three function keys Fn, FnLock, and Pn and the alternative key layouts for the three key zones of numeric key zone, editing key zone, function key zone will become the 6 most important features of a small-size keyboard.

The Pn function key can also be named otherwise like Fn 1. In another invention of the inventor of the present invention, the Pn function key and the corresponding function key layout will be described in detail.

If a signal is received that the Fn function key is pressed, and then a signal is received that another key is pressed and then released quickly, the corresponding Fn combination key operation will be executed.

Correspondingly, this key is configured to additionally show a number or a symbol, or an editing key prompt string or icon, or a function key prompt string that corresponds to the number or symbol entry operation, editing operation or function operation; if a signal is received that the Fn function key is released, this Fn combination key operation is stopped.

Referring to FIG. 2, if the keyboard function extension software NeweasyKeyboard installed in the computer system receives a signal through the WH_KEYBOARD_LL hook function module that the Fn function key is pressed, and then receives a signal that the letter key Q is pressed and then released quickly, i.e., the user presses the letter key Q once, the software will execute the Fn+K combination key operation once. Based on the kbd_event( ) function, the software executes once the Home editing operation that corresponds to the editing key prompt strings Home additionally shown on the letter key Q; if a signal is received that the Fn function key is released, this Fn combination key operation is stopped. Thus, the key entry operation to substitute the editing key Home in the editing key zone is realized through the Fn key combination.

For example, after a computer user holds down the Fn function key, and then holds down the Shift function key, and continuously presses the letter key D additionally showing the editing key prompt icon → for three times, the Fn combination key operation will be executed, i.e., the Shift+Right editing combination key operation that corresponds to the additionally shown editing key prompt icon → will be executed for 3 times; when the Shift function key is released, the Shift combination key operation will be stopped; when the Fn function key is released, this Fn combination key operation is stopped.

For another example, after a computer user holds down the Fn function key, and then holds down the Ctrl function key, and press once the letter key D that additionally shows the editing key prompt icon →, the Fn combination key operation will be executed, i.e., the Ctrl+Right editing combination key operation that corresponds to the additionally shown editing key prompt icon →will be executed once; when the Ctrl function key is released, the Ctrl combination key operation is stopped; when the Fn function key is released, this Fn combination key operation is stopped.

For a further example, after a computer user holds down the Fn function key, and then presses once the letter key F that additionally shows the editing key prompt string PgDn, the PageDown editing operation corresponding to the editing prompt string PgDn will be executed once; if the letter key W additionally showing the editing key prompt icon ↑ is held down, the Up editing operation corresponding to the editing key prompt icon ↑ will be automatically executed for multiple times based on the time of holding; if the letter key V additionally showing the editing key prompt string Paste is pressed once, the Ctrl+V editing operation corresponding to the editing key prompt string Paste will be executed; the Fn combination key operation will not be stopped till the Fn function key is released.

When a signal is received that the space bar is held down, and then there is no further signal that another key is pressed, instead, a signal is received within 1 second or other preset time that the space bar is released, a space character will be entered; when a signal is received that the space bar is held down, and then there is no further signal that another key is pressed, instead, a signal is received after 1 second or other preset time, a space character will not be entered.

At present, automatic and continuous entry of multiple space characters by holding down the space bar is seldom operated. Therefore, the operation of holding down the space bar is used to execute the Fn function key operation, not for automatic and continuous entry of space characters. This will have little influence on the input operation habit of users. Users can realize automatic and continuous entry of multiple space characters in many ways.

In the present invention, the Fn function key has two key functions of Space and Fn at the same time. When pressed once to enter a space character, the Fn function key is equal to a space bar, and is therefore fully compatible to the conventional space character input habit; when held down to execute the corresponding Fn combination key operation, the Fn function key is equal to an Fn combination function key. Alternative key entry in the main key zone to substitute the numeric key zone, editing key zone, and function key zone can greatly enhance the keyboarding experience using a small-size keyboard.

The RightShift function key of the computer keyboard is by default configured as the FnLock lock function key; also, other function keys like the Fn key can be configured as the FnLock lock function key; also, combination keys like Fn+CapsLock, Fn+Shift etc can be configured as the FnLock lock function key; and the FnLock lock function key is additionally marked with corresponding function prompt strings or icons like FnLock, Fn+=FnLock, EditNumLock etc.

For example, referring to FIG. 2, the NeweasyKeyboard keyboard function enhancement software installed and run in the computer system configures the Fn+CapsLock combination key on a small-size keyboard as the FnLock lock function key; and by changing the key cap of the mechanical keyboard, the CapsLock function key additionally shows the corresponding function prompt string FnLock. Just like Home is marked below the letter Q, FnLock can be marked below the CapsLock, and naturally, the function operation corresponding to Fn+CapsLock combination key is FnLock.

For example, the driver of a small-size keyboard configures the Fn+Shift combination key on the small-size keyboard as the FnLock lock function key; and by changing the key cap of the mechanical keyboard, the two Shift function keys can additionally show the corresponding function prompt string Fn+=FnLock.

For example, on the conventional small-size keyboard, the Fn function key is only used as a combination key. Through function extension, the Fn function key can have two functions at the same time, i.e., the function key and the lock function key. When the user holds down the Fn key and presses the other key once, it is an Fn combination function key; when pressing the Fn key once, it is an FnLock lock function key.

It is determined by the default settings or user-defined settings of keyboard manufacturers, computer manufacturers, or software providers whether or not the small-size keyboard is configured with an FnLock lock function key; or which independent key or combination key on the small-size keyboard is configured as the FnLock lock function key; or how the function prompt string or icon is shown on the FnLock lock function key.

For example: Based on the default settings of computer keyboard manufacturer IKBC, the driver of IKBC small-size keyboard by default configures the RightShift function key as the FnLock lock function key, and the RightShift function key is additionally marked with a function prompt string FnLock; Based on the default settings of computer keyboard manufacturer RK, the driver of RK small-size keyboard by default configures the CapsLock function key as the FnLock lock function key, and the CapsLock function key is additionally marked with the function prompt string EditNumLock; through user-defined settings, the RightShift function key on the RK small-size keyboard is configured as the FnLock lock function key, and by replacing the key cap on the mechanical keyboard, the RightShift function key can additionally show the function prompt string FnLock.

FnLock, CapsLock, and NumLock are all lock function keys. Therefore, without changing the physical key layout of the computer keyboard, the integration of FnLock or RightShift is the best technical solution for the FnLock lock function key.

In the main key zone of the small-size keyboard, the 15 right-hand basic keys in 3 rows and 5 columns are the alternative layout for the numeric key zone. However, there are 17 keys in the standard numeric key zone. The Enter and NumLock key are missing. On the rightmost of the main key zone, there is an Enter function key, which can be regarded as an alternative key layout of the Enter key in the numeric key zone; and there is a RightShift function key that is configured as the FnLock lock key, which can be regarded as an alternative key layout of the NumLock lock key in the key zone. Therefore, by optimizing the Enter and RightShift function keys in the main key zone, it is equal to providing a complete alternative key layout for the numeric key zone. This is also an important reason to configure the alternative key layout for the numeric key zone on the right-hand basic keys.

The technique to realize the configuration of an independent key or a combination key on the computer keyboard through the driver or the corresponding keyboard function enhancement software as the FnLock lock function key is similar to configuring the lock function keys of CapsLock and NumLock etc. It is a publicly known prior-art technology. The present invention does not intend to limit the specific means of realization of the FnLock lock function key.

The computer keyboard is by default configured to be in the FnLock exit mode; in the FnLock exit mode, if a signal is received that the FnLock lock function key is pressed once, the keyboard will be shifted to the FnLock lock mode; in the FnLock lock mode, if a signal is received that the FnLock lock function key is pressed once, the keyboard will be shifted to the FnLock exit mode.

Referring to FIG. 2, based on the FnLock lock function key, there are two input modes: FnLock lock mode and FnLock exit mode. The driver of the small-size keyboard configures the preset initial input mode of the CapsLock lock function key as the FnLock exit mode. When the signal of a Fn+CapsLock combination key operation is received, the driver of the small-size keyboard will shift the mode to the FnLock lock mode; in the FnLock lock mode, if a signal of another Fn+CapsLock combination key operation is received, the driver of the small-size keyboard will shift the mode to the FnLock exit mode; when signals of multiple continuous Fn+CapsLock combination key operations are received, the driver of the small-size keyboard will sequentially cycle between the two modes of FnLock exit mode and FnLock lock mode.

Because, by default, pressing the RightShift function key once is operated with the right hand, in order to for the left hand to be also able to operate the shifting between the FnLock lock mode and the FnLock exit mode, the Fn+CapsLock combination key can at the same time be configured as the FnLock lock function key. Thus, except by pressing the RightShift once through the right hand, shifting between the FnLock lock mode and the FnLock exit mode can also be realized through operation of the combination key like the Fn+CapsLock, thus providing better keyboarding experience for users.

The preset initial input mode of the CapsLock key is lowercase lock mode; the preset initial input mode of the NumLock is numbers lock mode. Just like all other lock function keys have a preset initial input mode, the FnLock also has a preset initial input mode, i.e., FnLock exit mode, and by default, the conventional letters, symbols, and numbers will be entered instead of alternative key entry of the numeric key zone, the editing key zone, and the function key zone, thus being perfectly compatible to the conventional operation habit of users.

Just like by continuously pressing the CapsLock lock function key once, the operation mode can sequentially cycle between the lowercase lock mode and upper case lock mode; just like by continuously pressing the NumLock lock function key once, the operation mode can sequentially cycle between the numbers lock mode and numbers exit mode; by continuously pressing the FnLock lock function key once, the operation mode can sequentially cycle between the FnLock lock mode and FnLock exit mode.

By default, when the RightShift lock function key is pressed once, the operation will shift between the FnLock lock mode and FnLock exit mode. If the user feels the operation gets faulty more easily, the user can self-define the keyboard driver to configure the operation of quickly pressing the RightShift lock function key twice for shifting between the FnLock lock mode and FnLock exit mode, thus catering to personalized requirements.

In the FnLock exit mode, when a signal is received that any key in the main key zone of the computer keyboard is pressed once, the keyboard driver will execute the preset input operation corresponding to the conventional letter or symbol shown on this key.

For example, in the small-size keyboard preset FnLock exit mode, when a signal is received that the letter key A is pressed once, the keyboard driver will execute the preset letter input operation corresponding to the Letter A conventionally shown on this key, i.e., lowercase Letter A is entered; when a signal is received that the letter key L is pressed once, the keyboard driver will execute the preset letter input operation corresponding to the letter L conventionally shown on this key, i.e., the lowercase letter 1 is entered; when a signal is received that the numeric key 2 is pressed once, the keyboard driver will execute the preset number input operation corresponding to the Number 2 conventionally shown on this key, i.e., number 2 is entered.

In the initial preset FnLock exit mode, the input operation in the main key zone of the computer keyboard is totally the same as the conventional input mode, and is therefore perfectly compatible to the conventional input habit.

In the FnLock lock mode, when a signal is received that any key in the main key zone of the computer keyboard is pressed once, the keyboard driver will execute the number or symbol input operation, the editing operation or the function operation corresponding to the number or symbol, the editing key prompt string or icon, or the function key prompt string additionally shown on this key.

For example, in the small-size keyboard preset FnLock lock mode, when a signal is received that the key conventionally showing Letter A is pressed once, the keyboard driver will execute the editing operation corresponding to the function prompt icon ← additionally shown on this key, and a Left move editing operation is conducted; when a signal is received that the key conventionally showing Letter L is pressed once, the keyboard driver will execute the number input operation corresponding to Number 6 additionally shown on this key, and a number 6 is entered; when a signal is received that the key conventionally showing Number 2 is pressed once, the keyboard driver will execute the function operation corresponding to the function prompt string F2 additionally shown on this key, and an F2 function operation is conducted.

When the FnLock lock function key is pressed once to shift to the FnLock lock mode, the input operations of most of the keys in the main key zone of the computer keyboard are greatly different from the conventional input mode, only very few keys maintain the same functions. The different functions are mainly used for alternative key input of the numeric key zone, the editing key zone, and the function key zone.

On the full-size keyboard, the preset input modes of the numeric key zone, the editing key zone, and the function key zone are independent key input modes, not combination key input mode. Therefore, the alternative key input modes of the numeric key zone, the editing key zone, and the function key zone through main key zone of the small-size keyboard shall not only include the combination key input mode based on Fn, but also include the key input mode based on FnLock. Without this, the perfect keyboarding experience of users cannot be realized.

In the computer keyboard, based on the driver or the corresponding keyboard function enhancement software, the user can press the FnLock key once to shift the input mode to the FnLock lock mode for alternative key input of the numeric key zone, the editing key zone, or the function key zone. And the user can press the CapsLock key once to shift the input mode to the upper case input mode for entry of upper case letters. The technique to realize such input modes are totally the same. Just like by pressing the NumLock key once to shift the editing input mode for editing key operation, the technique to realize such input modes are also the same. The techniques to realize the default independent key input modes in the numeric key zone, the editing key zone, and the function key zone of the full-size keyboard are also completely identical. The present invention has no restrictions on the specific method adopted to realize the cycling between the Fn_Lock lock mode and the FnLock exit mode by pressing the FnLock lock function key once, and the method adopted to realize alternative key input of the numeric key zone, the editing key zone, and the function key zone in the FnLock lock state through an independent key input mode.

wherein the 46 keys in the main key area of the computer keyboard correspondingly display “15 numerals or symbols, 15 editing key prompts or icons, and 16 functional key prompts” to replace the keys of the “editing key area, numeral key area, and functional key area”;

the one-to-one display relationship between the character keys in the main key area of the computer keyboard and the “numerals or symbols, editing key prompts or icons, and functional key prompts” will depend on the default settings of the keyboard manufacturer and computer manufacturer, as well as the custom settings of users.

Although a plurality of embodiments of the present invention are described above, they are not intending to limit the scope of the invention. Knowing the basic innovative concept, technicians skilled in the art can easily make alternative changes or modifications to the embodiments described above. Therefore, the claims of the present invention shall be construed to cover all the above embodiments and all other alternative changes or modifications that fall within the scope of the invention.

Obviously, technicians skilled in the art can make various modifications and transformations to the present invention without departing from the spirit and scope of the present invention. Therefore, if such modifications or transformations to the present invention are covered by the claims of the present invention and scope of equivalent techniques, such modifications and transformations shall also be covered by scope of the present invention.

We claim:

1. A small keyboard with alternative layouts for numbers, editing, and function keys, a main key zone of the keyboard comprising
an editing alternative key zone, a numeric alternative key zone and a function alternative key zone;
wherein the editing alternative key zone corresponds to 15 keys in 3 rows and 5 columns on a left side of the main key zone;
the numeric alternative key zone corresponds to 15 keys in 3 rows and 5 columns on a right side of the main key zone right;
the function alternative key zone corresponds to 13 keys on a left side of a first row and 3 keys on a right side of a second row of the main key zone;
each key in the main key zone of a QWERTY small-size keyboard can correspond to a second key function, a space key corresponds to a Fn key function, and a right Shift key corresponds to a FnLock key function;
when the space key is pressed, the Fn key function is activated;
when the right Shift key is pressed once, the Fn key function is activated;
when the Fn key function is activated, the second functions of all keys in the main key zone are activated.

2. The small keyboard with alternative layouts for numbers, editing, and function keys defined in claim 1, wherein the QWERTY small-size keyboard includes an editing alternative key zone; the editing alternative key zone includes 15 keys in 3 rows and 5 columns, such as Q key, W key, E key, R key, T key, A key, S key, D key, F key, G key, Z key, X key, C key, V key, and B key;
each key in the editing alternative key zone corresponds to a second key function, such as Q key corresponds to Home function, W key corresponds to ↑ function, E key corresponds to End function, R key corresponds to PageUp function, T key corresponds to Insert function, A key corresponds to ← function, S key corresponds to ↓ function, D key corresponds to → function, F key corresponds to PageDown function, G key corresponds to Delete function, Z key corresponds to Undo function, X key corresponds to Cut function, C key corresponds to Copy function, V key corresponds to Paste function, and B key corresponds to Redo function.

3. The small keyboard with alternative layouts for numbers, editing, and function keys defined in claim 1, wherein the QWERTY small-size keyboard includes a numeric alternative key zone; the numeric alternative key zone includes 15 keys in 3 rows and 5 columns, i.e., Y key, U key, I key, O key, P key, H key, J key, K key, L key, ; key, N key, M key, key, . key, and / key;
each key in the numeric alternative key zone corresponds to a second key function, i.e., Y key corresponds to − function, U key corresponds to 7 function, I key corresponds to 8 function, 0 key corresponds to 9 function, P key corresponds to + function, H key corresponds to * function, J key corresponds to 4 function, K key corresponds to 5 function, L key corresponds to 6 function, ; key corresponds to 0 function, N key corresponds to / function, M key corresponds to 1 function, key corresponds to 2 function, . key corresponds to 3 function, and / key corresponds to function.

4. The small keyboard with alternative layouts for numbers, editing, and function keys defined in claim 1, wherein the QWERTY small-size keyboard comprises an function alternative key zone; the function alternative key zone includes 16 keys, i.e., Esc key, 1 key, 2 key, 3 key, 4 key, 5 key, 6 key, 7 key, 8 key, 9 key, 0 key, − key, = key, [ key, ] key, and \ key.
each key in the function alternative key zone corresponds to a second key function, i.e., Esc key corresponds to ′ function, 1 key incorporates F1 function, 2 key incorporates F2 function, 3 key incorporates F3 function, 4 key incorporates F4 function, 5 key incorporates F5 function, 6 key incorporates F6 function, 7 key incorporates F7 function, 8 key incorporates F8 function, 9 key incorporates F9 function, 0 key incorporates F10 function, − key incorporates F 11 function, = key incorporates F12 function, [ key incorporates Pause function, ] key incorporates ScrLK function, and \ key incorporates PrtSc function.

5. The small keyboard with alternative layouts for numbers, editing, and function keys defined in claim 1, wherein, in the main key zone of a QWERTY small-size keyboard, the corresponding second key function of each key is marked on the key cap of each key in the main key zone, the key cap of the space bar key is marked with Fn, the key cap of the right Shift key is marked with FnLock.

6. The small keyboard with alternative layouts for numbers, editing, and function keys defined in claim 1, wherein, when the space bar is held down, the Fn key function is activated, and when the space bar is released, the Fn key function is deactivated.

7. small keyboard with alternative layouts for numbers, editing, and function keys defined in claim 1, wherein, the Fn key function is activated, by pressing the right Shift key once and the Fn key function is deactivated by pressing the right Shift key once again, when the right Shift key is pressed for multiple times, the Fn key function is cycled between the activated mode and deactivate mode.

8. The small keyboard with alternative layouts for numbers editing, and function keys defined in claim 1, wherein, by holding down the Fn key or press the FnLock key once to activate the Fn key function, the second key functions of all keys in the main key zone will be activated; by releasing the Fn key or pressing the FnLock key once again to deactivate the . Fn key function, the second key functions of all keys in the main key zone will be deactivated.

9. The small keyboard with alternative layouts for numbers, editing, and function keys defined in claim 1, wherein the 46 keys in the main key area of the computer keyboard correspondingly display “15 numerals or symbols, 15 editing key prompts or icons, and 16 functional key prompts” to replace the keys of the “editing key area, numeral key area, and functional key area”;
the one-to-one display relationship between the character keys in the main key area of the computer keyboard and the “numerals or symbols, editing key prompts or icons, and functional key prompts” will depend on the default settings of the keyboard manufacturer and computer manufacturer, as well as the custom settings of users.
